(19) United States
(12) Patent Application Publication
(10) Pub. No.: US 2009/0327953 A1
(43) Pub. Date: Dec. 31, 2009

(54) UNIFIED NAVIGATION MODEL BETWEEN MULTIPLE APPLICATIONS

(75) Inventors: Mikko Honkala, Helsinki (FI); Kimmo Kinnunen, Espoo (FI); Guido Grassel, Espoo (FI); Yan Qing Cui, Beijing (CN); Virpi Roto, Espoo (FI); Mika Rautava, Espoo (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/165,046

(22) Filed: Jun. 30, 2008

(51) Int. Cl. G06F 3/048

(52) U.S. Cl. 715/804

(57) ABSTRACT

Web style navigation methods are applied across applications and webpages, whether local or web-based, and hypertext navigation methods used in the web are extended to local applications. Local and web applications are mixed seamlessly so that the user does not perceive any difference between navigation within either one of, or between, those types of applications. The user navigates between different user interface states, in and out of different types of applications. All views and states of views are recorded and the user can switch to a previous view, in the state in which it was viewed, using a back, history or other suitable state recording and retrieval function.

### BACKGROUND

1. Field

The aspects of the disclosed embodiments generally relate to user interfaces and more particularly to unified navigation between applications and the use of web-based navigation methods with local applications and processes.

2. Brief Description of Related Developments

Opening more than one application in or with a device generally involves opening separate instances of each application, each instance or application running in a different window. To switch between applications, one must select the desired application window or view. When operating on the Web, the “Back” and “Forward” functionality of the browser or interface will generally allow a user to traverse backwards and forwards along a historical or hierarchical chain of sites that have been visited. In a mix of local applications and web-based applications, there is no such similar feature or functionality.

There are changes in how software applications and services are being implemented and deployed. Previously, the services were installed as applications in the user's local device, such as a PC or a smartphone. The new trend is to deploy services as web-based applications, accessed with a generic browser. However, there are many scenarios where local applications need to be used (because of offline capability, or computing requirements, etc.).

In the case where local applications are used, it is often necessary to integrate them with web applications. For instance, a local contacts list application might contain a link to a contact photo collection, which resides in a service on or accessible via the web. In this case, it is typical that a new browser window is launched. To go back to the local application, the user has to switch between the windows using a window manager, or in some cases, close the web browser. There is typically no way to go “back” to the application and then go “forward” to the web page again without changing windows. Desktop platforms allow for opening a new browser window while keeping the application window running in background. For simple operations, such as opening a single browser window, some mobile platforms provide support for going back to the launching application with the “back” soft key. However, forward navigation is not supported.

In some instances, there can be interlinking between two local applications. From within one application, there is a link, such as a hypertext link, to another application. Activating the link will launch or open the other application. Typically, such situations launch new instances of each of the applications, with each application or instance thereof running in a separate window. After completing a task in an application launched from within another application, the second application stays open until the user closes it. The user cannot resume what they were doing, or go back to the original application, except by selecting the original application or closing the second launched application. The user needs to explicitly exit the application and in some cases, locate the application that was first used.

There are also situations where secure local functionality is integrated into a web application. For instance, a web application might need or allow the user to select and import a message recipient's email address directly from an address book or contact application that is local to the device. Once a contact is selected from the address book, this local application needs to navigate back to the web application with the contact data, such as the recipient's email address, as a parameter. A current problem is that the addressing and navigation model is different between the local and the web-based application, and it is generally not possible to achieve this back and forth navigation in a simple or usable manner.

Problems with all of the cases above include non-unified bookmarking and history, hyperlink, and back-forward navigation models. While Web applications allow intra- and inter-application hypertext linking, this model does not extend to the local applications. It would be advantageous to be able to mix and move seamlessly between applications, as well as between local and web applications, in a user interface without any perceptible differences in the navigation model.

On Web browsers, the “Back” operation or function tends to be one of the most used functionalities. The “Back” function generally allows one to return to a previously visited Web page. Similarly, the “history” functionality of a web browser is often used. The “history” operation will generally take one back to a list of previously visited Web pages. A user can then select from any one of the listed Web sites to return to the Web site. Browsing can generally create a long history of visited pages, and Web browser will generally provide the ability to step or jump back several Web pages at once, whereas the Back function generally jumps back one page at a time. A history menu in a Web browser is generally where previously visited pages appear, and can group pages according to time and web domain, for example. In a mobile device, where screen size can be limited, providing multi-stepping back functionality can be difficult. Searching or parsing the history menu can also be difficult due to the limited screen size and difficulties in text entry. It would be advantageous to be able to provide a compact and concise history list that is easily navigated using a device that has limited screen or display area.

In a personal computer (PC), due to the availability of large screen views, multiple windows can be visible and used substantially simultaneously. A user can switch between windows when needed. In smaller devices, where screen real estate is limited, multiple windows are not optimal for task switching. It would be advantageous to be able to track ongoing tasks and return to another view in a device that has limited screen or display area.

Ordinary Web browsers will generally provide functions by which to store links to web pages that are important or commonly visited. These functions are generally referred to as Bookmarks or Favorites. In a mobile device it would be advantageous to be able to identify important Web pages and provide links to more important Web pages automatically.

Similar to web browsing, a mobile device treats each individual view as a unit of analysis and users are able to freely navigate between views. A “view” as that term is used herein, generally refers to the counterpart of a web page in a mobile device whose user interface is based on associative browsing. When navigating through a number of views, the navigation history can grow quickly, and the history list may become too long to be usable. It would be advantageous to be able to analyze and process each view in a mobile device in a meaningful way to reduce the number of views in the history list and provide a usable history.

### SUMMARY

The aspects of the disclosed embodiments are directed to at least a system, method, apparatus and computer program product for applying Web style navigation methods across applications and webpages, whether local or web-based. Hypertext navigation methods used in the web are extended to local applications. Local and web applications are mixed seamlessly so that the user does not perceive any difference between navigation within either one of, or between, those types of applications. The user navigates between different user interface states, in and out of different types of applications. All views and states of views are recorded and the user can switch to a previous view, in the state in which it was viewed, using a back, history or other suitable state recording and retrieval function. Individual views are processed in terms of objects and actions in order to categorize views in terms of importance as well as to provide streamlined history lists.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2A illustrates an example of a process flow incorporating aspects of the disclosed embodiments;

FIG. 2A1 illustrates examples of a hierarchical and networked navigation structure;

FIG. 2B illustrates one example of view processing incorporating aspects of the disclosed embodiments.

FIG. 2C illustrates an exemplary history view incorporating aspects of the disclosed embodiments;

FIGS. 2D-2I are exemplary screen shots from a user interface incorporating aspects of the disclosed embodiments.

FIG. 3 illustrates an exemplary user interface incorporating aspects of the disclosed embodiments;

FIGS. 4A-4D illustrates exemplary applications of aspects of the disclosed embodiments;

FIGS. 5A and 5B illustrate an exemplary embodiment;

FIGS. 6A and 6B are illustrations of exemplary devices that can be used to practice aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which the devices of FIGS. 6A and 6B may be used.

### DETAILED DESCRIPTION OF THE EMBODIMENT(S)

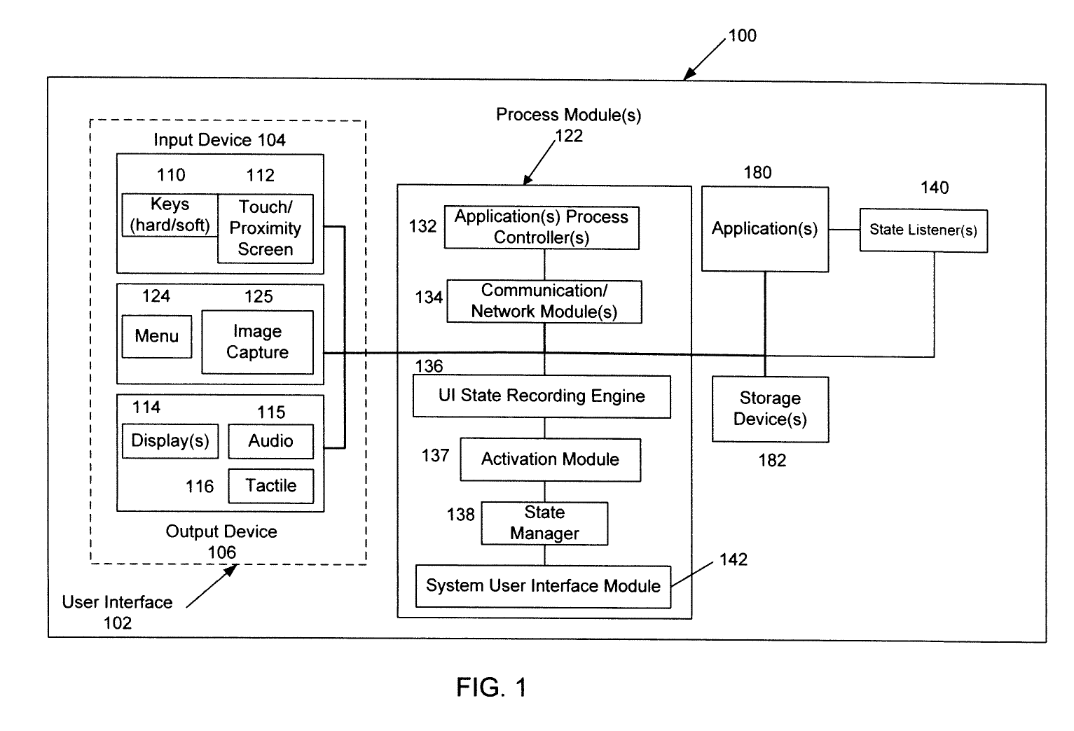

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments integrate the navigation methods of local applications and Web applications and use the same core navigation methods for navigating in and between both local and web applications. The navigation methods used in web applications are generally extended to local applications and programs. An application can include many screens and views, where each view belongs to only one application. The aspects of the disclosed embodiments allow a user to navigate to and from, and interact with, one or more views.

In one aspect, the disclosed embodiments provide a network of views, with unidirectional links between views. Each view can provide specific information and allow for specific interaction by and with the user. Each view can be reachable from at least one other view, and a view may include hyperlinks to other views. In one embodiment, a user navigates between views using hyperlinks. In alternate embodiments, any suitable mechanism can be used to navigate between views, other than including hyperlinks.

A view can be local application based or web-based, and a user can navigate between and among local application views and/or web application views within the same window or screen of the user interface. The user does not have to open, close or switch between windows since the navigation model of the disclosed embodiments is “windowless.” The navigation between application and/or program views are mixed seamlessly, so that the user does not perceive any difference between navigation in and between applications and/or programs. For description purposes herein, navigation between applications and/or programs is intended to include and comprise navigation to and interacting with one or more views.

A view can have one or more states and the user navigates between different states of the user interface. In one embodiment, a user enters a view in its default state, unless the user enters the view using for example, the history function, which provides, or brings the user to, a specific state of a view. A state of the user interface can include the visited view, and each selection, modification, deletion or addition of an object belonging to the view by the user or the system can create a different state. For example, actions such as playing a song in a media player, typing text in an SMS editor, taking a picture from within a camera view or deletion of a message from the inbox, will each create or result in a state. A media player playing song after song, such as traversing a playlist, creates a new or different state for each song. Additionally, interaction with an object in a view can be recorded as a distinct state. For example, a user panning a map can be one view state, and selecting or focusing on particular maps or geographic locations, such as “Helsinki” or “Espoo”, can be other, distinct view states.

In one embodiment, the granularity of the recording of different states can be configured by the user. The criteria for what comprises a view state can be the user perception of what makes one state distinct from neighboring states.

Self active views are views that make state progressions on their own, and create entries in the state recording function, even if the user has navigated away from the state. For example, music players and chat applications are instances of self-active views. These types of views may require that the user explicitly stop the view from progressing on its own.

The aspects of the disclosed embodiments generally extend hypertext navigation methods used in web applications to local applications and programs. Hypertext navigation methods are generally defined as the combination of some well-known patterns such as page activation by hyperlink navigation, page activation by back-forward navigation, bookmarking and page activation by bookmark activation and age activation via history search and browsing.

As the term is used herein, a web page is a page which is referenced with or by a Uniform Resource Locator (“URL”), transferred over Hypertext transfer protocol (“HTTP”), and rendered or presented to the user via the user's web browser. A web application is an entity, composed of one or more web pages. A view is a dialog in a local application that shows specific information and allows for specific interaction. A local application is one where the application is stored and executed by the user's local device. The local application can also be stored remotely from the local device, such as on a server, but must be accessible by the local device. A local application is an entity, which has one or more views. For instance, a typical mobile phone contact book application can have at least two views, a view of a contact list and a view of contact details.

Previously, to navigate between views, the user would typically have to select the view, which may open in a separate window on the display of the user interface. For example, to navigate between a web entity view and a local application view required switching between the different instances or windows. However, the aspects of the disclosed embodiments provide a seamless way to maintain a single window while switching between a web entity or application view and a local application view. By extending and improving the hypertext navigation methods used in web application navigation to local applications, the user does not perceive a difference in navigating between views between local applications or between local applications and web applications. The user merely navigates between different states of the user interface (“UI”).

Referring to FIG. 1, the system 100 of the disclosed embodiments can generally include input device 104, output device 106, process module 122, applications module 180, and storage/memory device(s) 182. The components described herein are merely exemplary and are not intended to encompass all components that can be included in the system 100. The system 100 can also include one or more processors or computer program products to execute the processes, methods, sequences, algorithms and instructions described herein.

The input device(s) 104 is generally configured to allow a user to input data, instructions and commands to the system 100. In one embodiment, the input device 104 can be configured to receive input commands remotely or from another device that is not local to the system 100. The input device 104 can include devices such as, for example, keys 110, touch screen 112, menu 124, a camera device 125 or such other image capturing system. In alternate embodiments the input device can comprise any suitable device(s) or means that allows or provides for the input and capture of data, information and/or instructions to a device, as described herein. The output device 106 is configured to allow information and data to be presented to the user via the user interface 102 of the system 100 and can include one or more devices such as, for example, a display 114, audio device 115 or tactile output device 116. In one embodiment, the output device 106 can be configured to transmit output information to another device, which can be remote from the system 100. While the input device 104 and output device 106 are shown as separate devices, in one embodiment, the input device 104 and output device 106 can be combined into a single device, and be part of and form, the user interface 102. The user interface 102 can be used to receive and display information pertaining to content, objects and targets, as will be described below.

The process module 122 is generally configured to execute the processes and methods of the disclosed embodiments. The application process controller 132 can be configured to interface with the applications module 180, for example, and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessed by the system 100, such as for example, office, business, media players and multimedia applications, web browsers and maps. In alternate embodiments, the applications module 180 can include any suitable application. The communication module 134 shown in FIG. 1 is generally configured to allow the device to receive and send communications and messages, such as text messages, chat messages, multimedia messages, video and email, for example. The communications module 134 is also configured to receive information, data and communications from other devices and systems.

In one embodiment, the aspects of the disclosed embodiments provide a user interface state recording engine or state library 136 for the local application user interfaces. The state library 136 is configured to track application states and forces the system 100 to return to a certain state from a current state. In one embodiment, the state library 136 receives state information from the state manager 138 and state listener(s) 140. The state manager 138 and state listener(s) 140 are configured to identify a state of the user interface and create a link, such as for example a hypertext link, related to the state, which can be recorded in the state library 136. Although a hypertext link will be generally referred to herein, in alternate embodiments, any suitable mechanism for providing an identifier and link to a specific state can be utilized, other than including a hypertext link. The state manager 138, in conjunction with the state library 136, can identify, monitor and track application states, and state changes, as well as respond to state change requests from a local application.

The system 100 can also include a system user interface module 142. In one embodiment, the system user interface module 142 is configured to control back-forward navigation, bookmarks and history functions as described herein.

In one embodiment the state listener(s) 140, also referred to as the state change listener 140, reside in each application 180. Each state listener 140 can be configured to notify the state manager 138 that a state change request has been made or that a state change has occurred. The state change recording engine 136 notifies each application 180, via the state listener, of possible state changes.

For example, an application changes its state. This change of state can occur for any number of reasons, including, for example, an external event or user interaction. The application 180, via the state listener 140, notifies the state recording engine 136 that the application state has changed.

As another example, the user selects a specific application state using the system user interface module 142. The selected state is enforced by the state recording engine 136. Enforcing a state of an application generally implies starting the application and getting the application to a specific, usually non-default state. The aspects of the disclosed embodiments allow an application to know how to save/record its state so that later on it can be brought back into the same state. For example, to save the state of a SMS editor view, this view would need to save the recipients of the edited message and the text content. Enforcing the state of the SMS application would mean opening the SMS editor view and setting the recipients and text content to what was saved.

The activation module 137 may start a new application with this state, or if the activation module 137 knows that the application is running already, it may reuse that running application and force the running application to change its state. In one embodiment, the activation module 137 is configured to work in conjunction with the state recording engine 136 and state manager 138, track the launching of any application from an existing state and force the application to automatically close when going to another view or state.

The state change request can come from outside the application, for example by the user navigating “back”, or from inside the application by calling a change state. Calling a change state can comprise for example an external event or user interaction. The back and history functions or commands are examples of external events. For example, a user is preparing an electronic mail message on the device. The device receives a call, which interrupts the preparation of the electronic mail message. In accordance with the aspects of the disclosed embodiments, the user can revert back or return from the call to the preparation of the electronic mail message. The state listener 140 can monitor the different hypertext navigation command functions, back, forward, history, home and bookmarks controlled by the system user interface module, and advise the state manager 138 when such a command is received during navigation.

In one embodiment, the system 100 can include a system user interface module 142. The system user interface module 142 can be configured to generate a task history list and present the task history list as described herein. The system user interface module 142 can also be configured to allow a user to interface with the views and functions described herein

The aspects of the disclosed embodiments generally provide each state with a unique identifier that can be used and referenced by the system. For example, in one embodiment an application state can be represented by a uniform resource locator (“URL”). In alternate embodiments, any suitable identifier can be used to reference a state. In the embodiment where the identifier comprises a URL, each URL can be locally addressable at any point in the future after its creation. Each URL has two main parts—the application and the application-specific state parameters. Referring to the above example of saving the state of a SMS editor view, the URL would need to include information including the SMS editor and the saved message. The state recording engine 136 creates the URL using the information provided by the view, namely the state parameters. The URL should include the application, which is used to construct the view, and application-specific parameters, which are used to initialize the state corresponding to the URL. A state can include one or more data members. In one embodiment, the main data members of a state will include a string URL, a string title, a string thumbnail URL and data date. In one embodiment there can be additional information per each state that is not embedded in the URL including for example, thumbnails, user readable titles and search terms. In one embodiment, the state information is stored in a persistent storage facility such as for example, storage device 182 or a relational database.

Certain states can be created and then rendered invalid by some action. In the situation where a state is deleted, the application, which is encoded in the representation of the state, must present meaningful content related to the state to the user. For example, in a messaging application, the main inbox view can be presented on the user interface, if the message referred to by the state is deleted.

Legacy applications, which do not expose the current state, only the launching of the application—along with any parameters—are tracked, and going “back” from such a legacy application effectively closes it. In one embodiment, the legacy application is similar to application(s) 180, except that the legacy application does not or may not have a link to the state listener 140 and state recording engine 136.

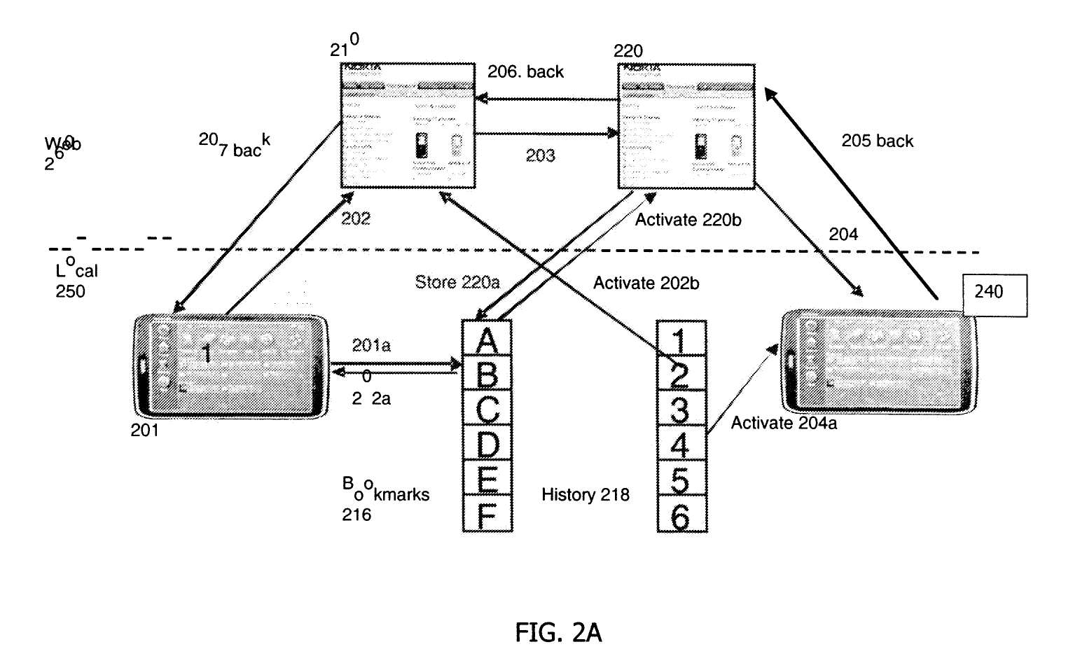

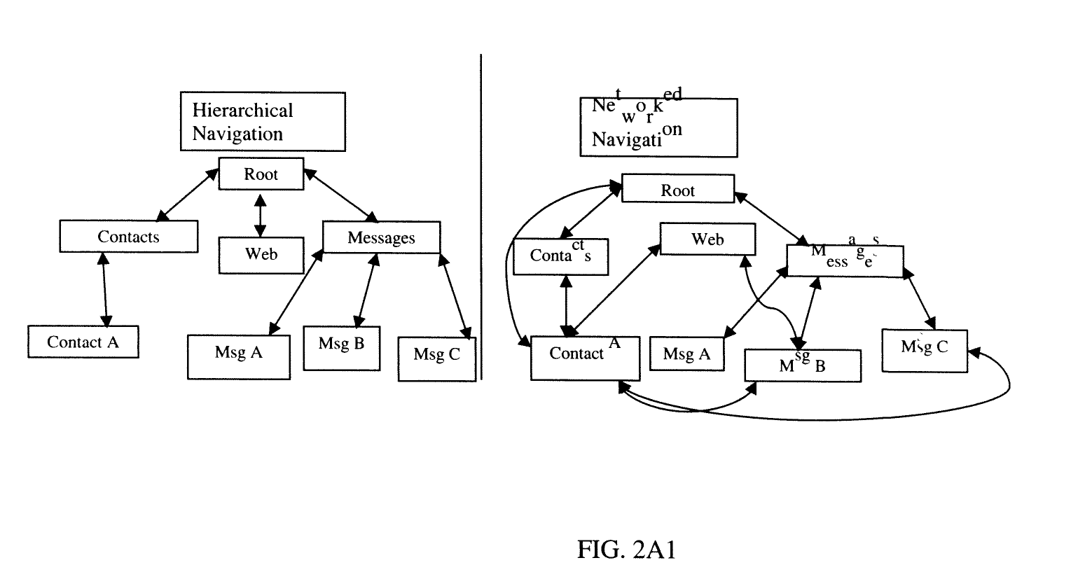

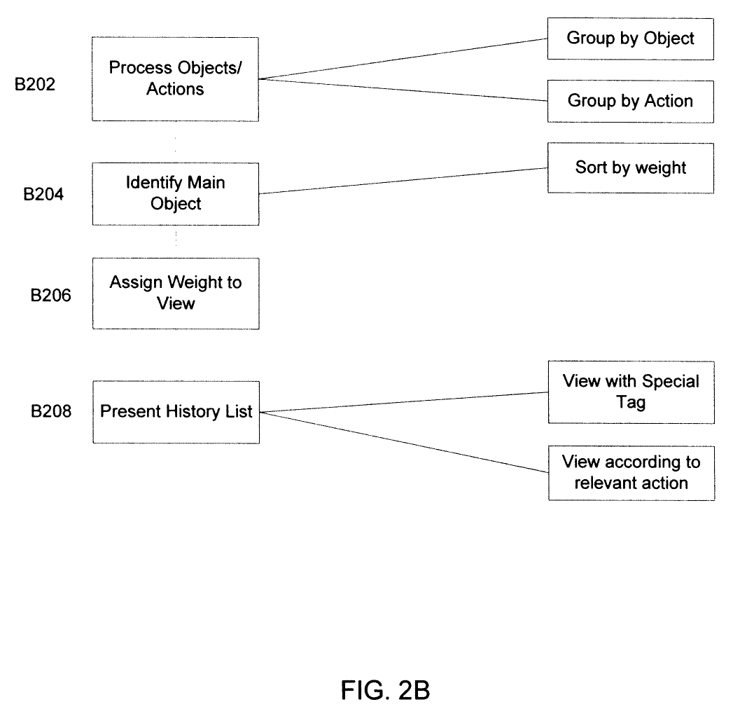

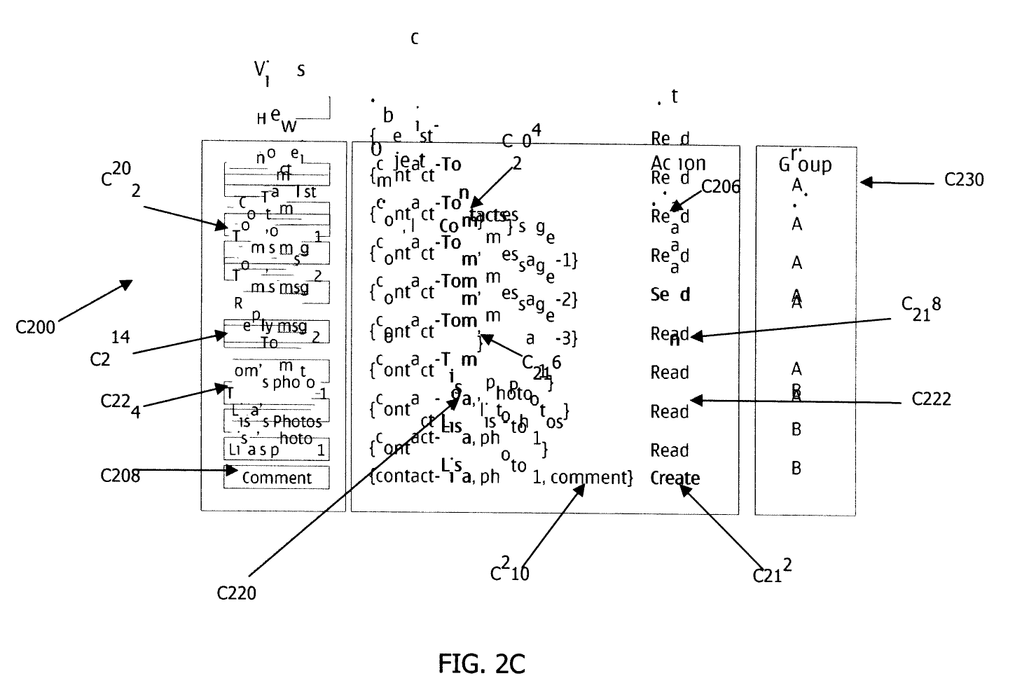

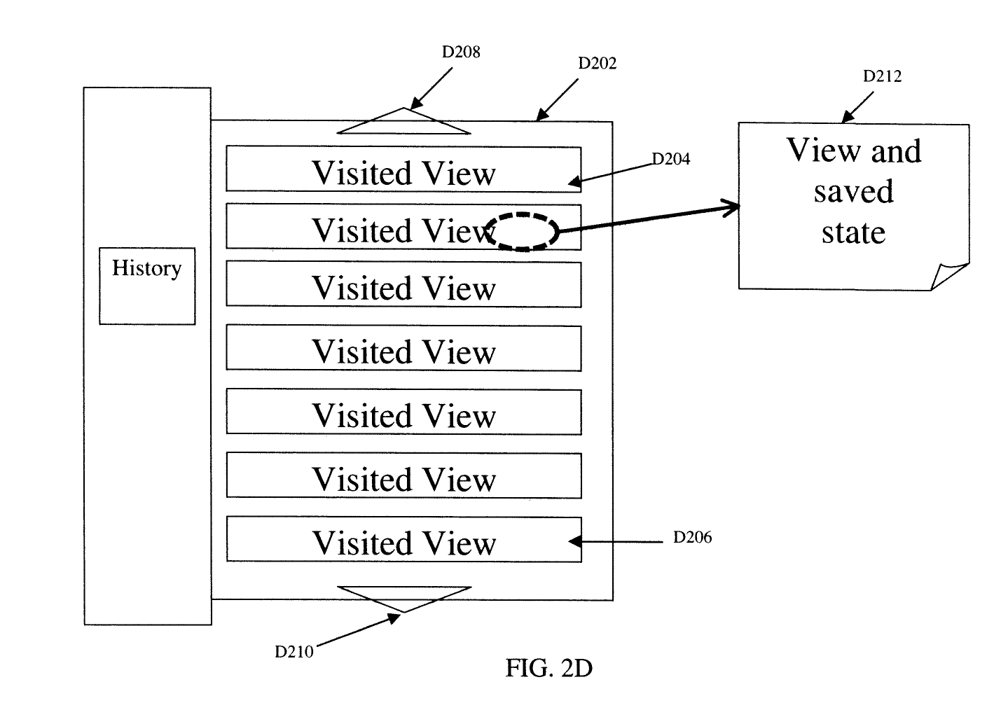

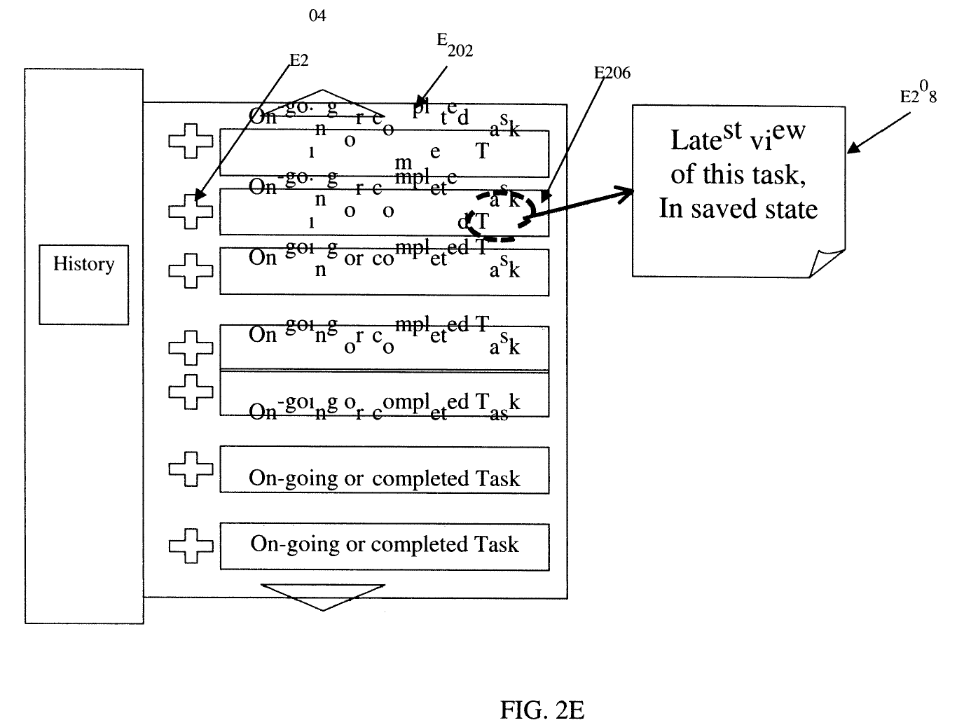

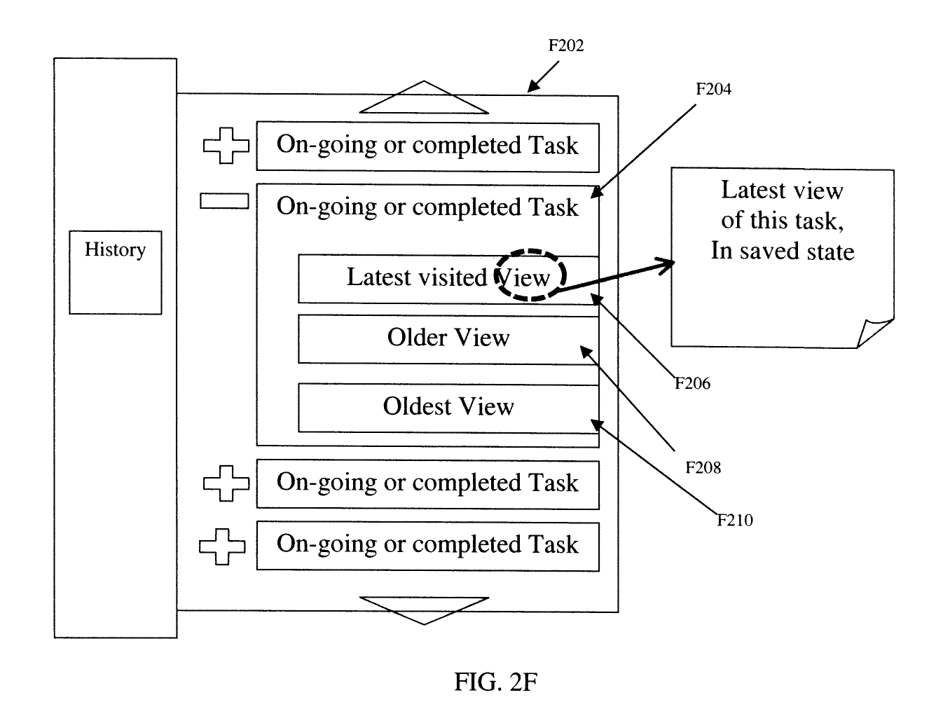

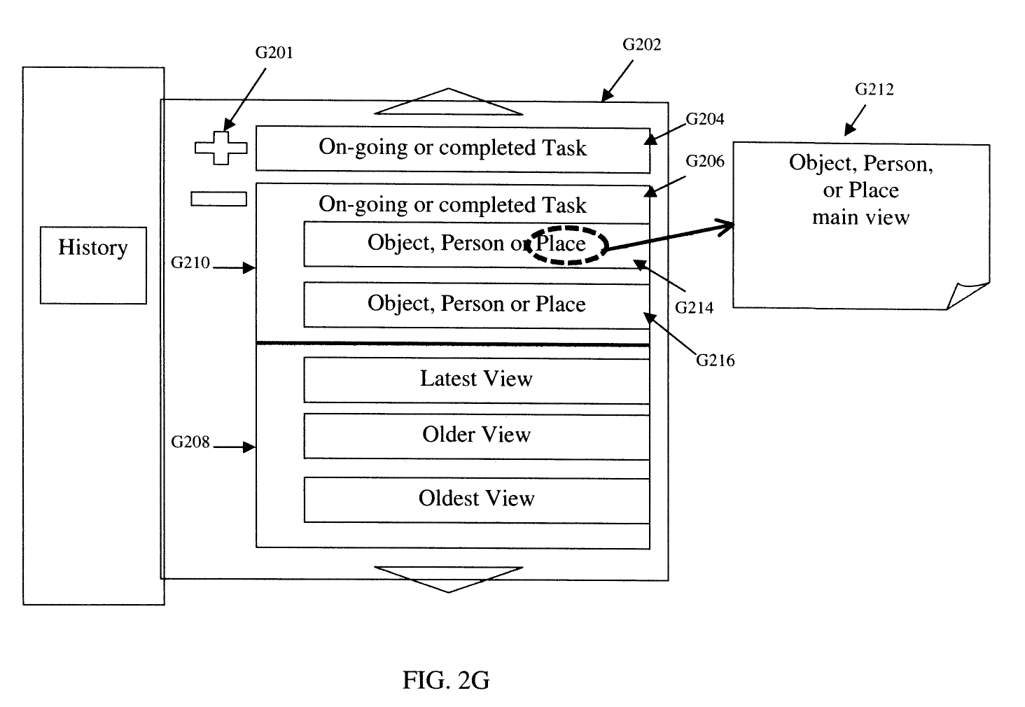

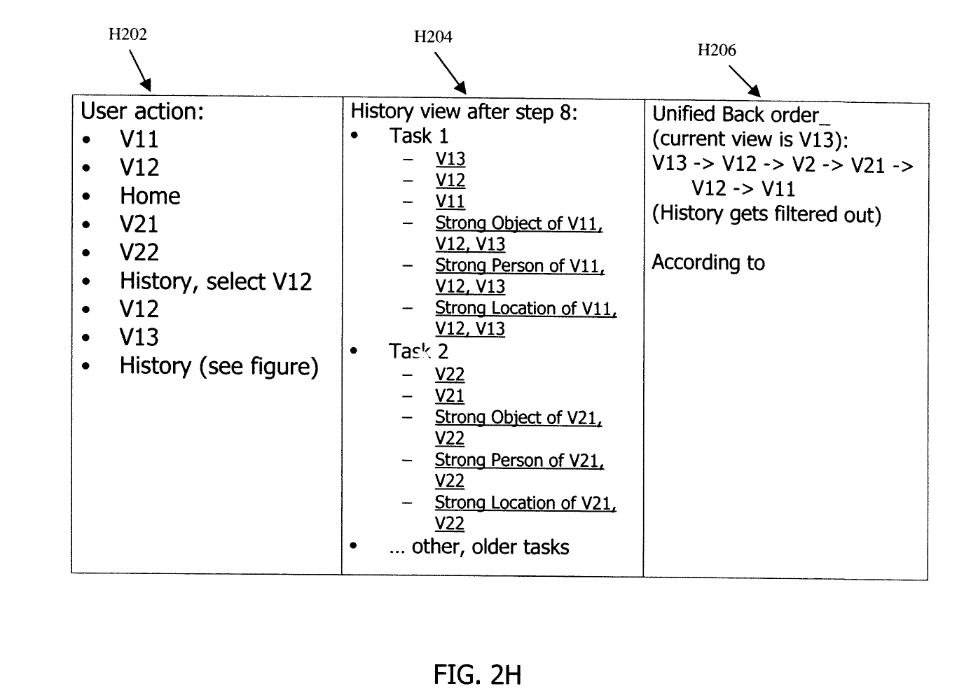

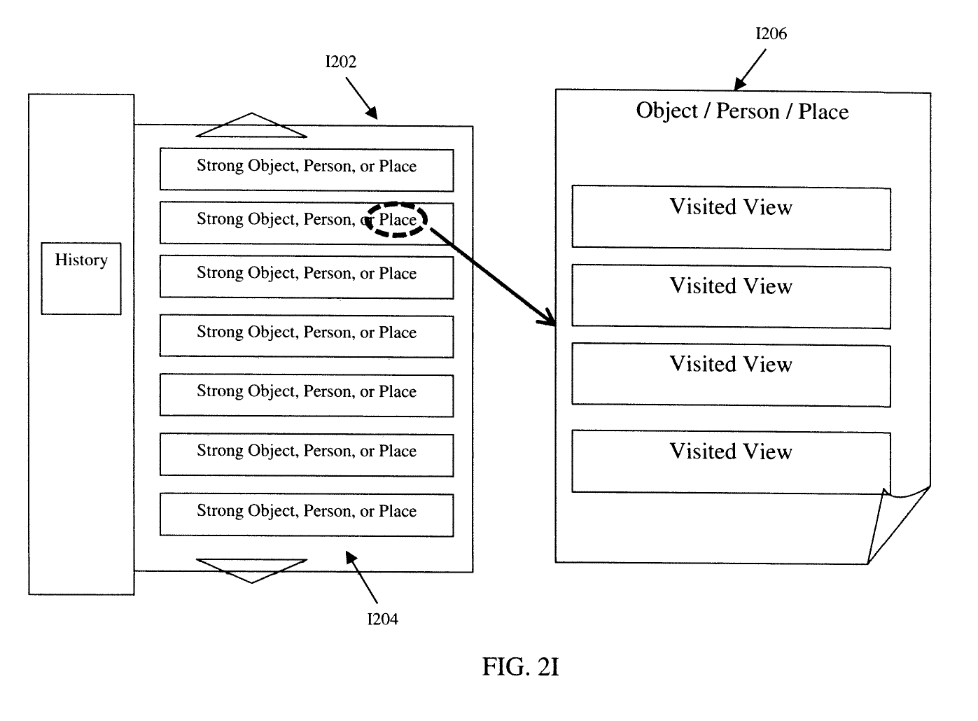

FIG. 2A illustrates one example of a navigation sequence in a system incorporating aspects of the disclosed embodiments. In this example, various navigation methods are used for navigating in and amongst local applications 250 and web applications 260. These navigation methods include for example, link activation, back functionality, history and bookmarks. In one embodiment, the “history” functionality is a timeline of all actions, while the “back” functionality is a “stack” of the current navigation path, and is a subset of history. Going “back” and navigating from there can remove the selected branch from the “back” stack and keep the others there, or make a duplication of the selected branch and keep the “old” branch were it was.

Each of these functions uses the same hypertext navigation methods that can be used with local applications, webpages and web applications. In embodiments that mix web-based applications and local applications, there is a perceived integration of webpages and local applications to the user. In the aspects of the disclosed embodiments, from the user perspective it does not matter whether a certain part of an application resides on the local device or whether it is implemented in the web. Thus, the aspects of the disclosed embodiments improve the usability of both local and web applications, particularly in situations where the local and web applications are interlinked.

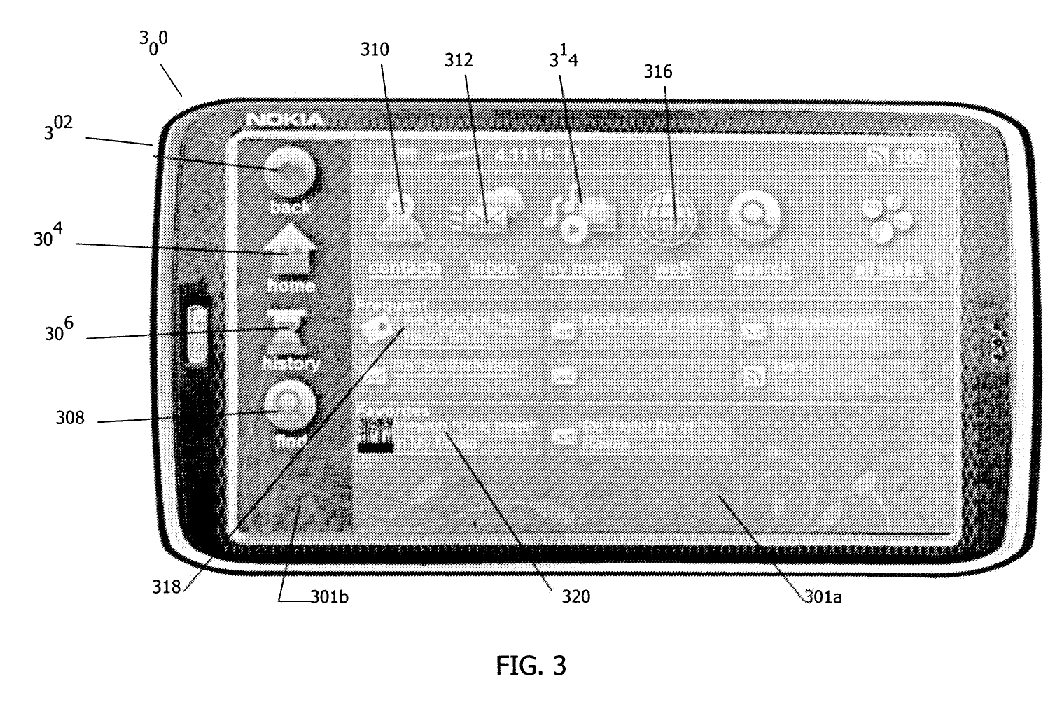

As shown in FIG. 2A, state 201 represents an initial state of the user interface of the disclosed embodiments. This initial state 201 can comprise a home screen for example, where the user is presented with one or more application related options. FIG. 3 illustrates one example of a user interface 300 incorporating aspects of the disclosed embodiments.

As shown in FIG. 2A, navigation from state 201 to states 202, 203 and 204 uses link activation. The navigation to states 205, 206, and 207, utilizes “back” navigation. As shown in FIG. 2A, a bookmark repository 216 and a history repository 218 are provided. A bookmark repository 216 and history repository 218 can include hypertext links to other applications and application states. Each local and web view state, 201-206, is stored in the history repository 218 of the device. The user can then use the history function 306 shown in FIG. 3 to switch between different tasks.

The bookmark repository 216 includes links A-F, which are links to local or Web applications. The user can store 201a links to webpages and local applications from the state 201. The history repository 218 includes links 1-6, which also include links to local applications or Web applications that the user has visited or has caused to be stored.

In FIG. 2A, the user navigates from state 201 to state 202 by activating 202a the bookmark link B. Activation of link B renders the page 210. The pages 210 and 220 are exemplary and can comprise a webpage or a view in a local application. Navigation to state 203 comprises activating a link on the page 210 that is currently being displayed on the user interface 201. The screen 220 is then shown or visible on the user interface. In one embodiment the link to the page 220 can be stored 220a in the bookmark repository 216. This allows the user to revert at any time to that state by selecting or activating a corresponding bookmark.

States 202 and 204 can also be reached by activating a corresponding function or link, a hypertext link, in the history repository 218. As shown in FIG. 2A, history link 2 will activate 202b the view to 210, which in this example corresponds to state 202, since it was the second state of the user interface. The fourth state of the user interface shown in FIG. 2A was the state 204, which corresponds to the user interface display 240. Thus, activation of history link 4 will render the state 204 corresponding to the user interface 240. In one embodiment, navigating to an old state actually recreates or clones that state and places the recreated state as the latest one in the history and back stack, rather than somehow transferring the user back to the specific history entry or event.

States 205, 206 and 207 are achieved using the “back” functionality of the user interface. The navigation model of the disclosed embodiments does not present a hierarchy of views, as is seen in most devices, but rather a network of views, as shown for example in FIGS. 2A and 2A1. For example, when using a browser, such as Internet Explorer™, the user can select or activate the “Back” function to traverse back to a previous page. One can also view the hierarchy of pages visited using an “Up” function. Selecting the “Up” function allows the user to traverse up the hierarchy chain, all the way to the first page viewed or visited.

The aspects of the disclosed embodiments will not present such a hierarchy of views. Rather, selection or activation of the “Back” function 302 in the user interface 300 shown in FIG. 3, will take the user to the view that linked the current view and where the user navigated from. For example, while the user is in state 204 of FIG. 2A, (corresponding to view 240) the user can activate the “back” function 302 to go to state 205, which takes the user back to the screen 220. In one embodiment, activating the “back” function returns the user to an exact state of a previous view prior to the activation of a link that led the user to a next view. The user also has the option to select a “home” function 304 to take the user from where they currently are back to the original view 201 in FIG. 2A.

In one embodiment, executing the “forward” function of the user interface 300 shown in FIG. 3 can cause an application state to be launched or web page to be opened. In one embodiment, the “forward” function key can comprise a softkey that is presented in a manner similar to that of the “back” key 320. In alternate embodiments, any suitable mechanism can be used to activate a forward function, including for example a hard key or voice command. The “forward” function, as used herein, generally implies an opposite use of the “back” function. While “back” opens a previous state from the current state, “forward” will open a next state from the current state. For example, referring to FIG. 2A, while in state 205, screen 220, if the user were to activate the “forward” function of the user interface 300, the user would navigate to state 204, screen 240.

Executing the “Back” functionality 302 can cause the current state, application or web page, to close. Thus, when traversing “back” from state 205, view 220, to state 206, view 210, the application or page represented by view 220 will close and the application or page represented by view 210 will open. All the navigation methods described above can require the same interaction by the user regardless of whether the state is a webpage view or a local application view.

As noted above, with respect to FIG. 2A, the history function or repository 218 can include hypertext links to other applications and application states. Each local and web view state, 201-206 can be stored in the history repository 218 of the device and the user can then use the history function 306 shown in FIG. 3 to switch between different tasks. The list of views in the history repository 218 can grow quickly as the activities increase. With a great deal of activity, the history repository 218 can become too large to be usable. The aspects of the disclosed embodiments can process the objects and actions involved and provide a history view or that is more concise and manageable.

The aspects of the disclosed embodiments will prioritize all the views and generate a concise history. In one embodiment, individual views are processed in terms of the objects and actions associated with the view. A view will typically contain one or more objects. For example, a contact card view has contact details, a photo browsing view contains a photo. In one embodiment, if a view does not have an evident object, a relevant object can be assigned to the view. For example, an empty editing view can have “note” as its object and a calculating view can have “calculator” as its object.

When a view has more than one object, all of the relevant objects in the view can be recorded. A main object in the view can be identified from all of the other objects, or a new object derived. For example, in one embodiment, the object “Contact” is the main object of a contact card view, even if the contact card view contains photos and images related to the contact. In alternate embodiments, any suitable object can be defined as the main object for a corresponding view.

In one embodiment, the history can focus on views with significant objects, actions or both. When analyzing a view, the individual objects and actions can be prioritized. For example, objects can be assigned different weights or levels to signify importance. In one embodiment, an object becomes more important when it is associated with actions with high weight in an adaptive user interface. An important object can generate a “cloud” in the same way as a tag cloud. A tag cloud, which can also be referred to as a weighted list, is generally used to define a visual depiction of user-generated tags or the word content of a web site. Tags can be single words, listed alphabetically, the importance of which can be illustrated by font, size or color, or some combination thereof, for example. Actions can be prioritized and weighted in a similar fashion.

Referring to FIG. 2B, an exemplary process flow for processing a view in terms of objects and actions is illustrated. In one embodiment, for a given view, the objects and actions involved are processed B202. A given view can involve one or more objects from different levels. In one embodiment, each relevant object will be examined and a main object identified B204 according to the assigned weight. In one embodiment, the main object is the object having a greater weight in comparison to any other objects in the view. For example, a contact card view can include objects such as contacts, as well as photos or images related to the contacts. In the contact card view, the main object is the contact. Thus, the contact of the contact card view is identified as the main object of the view.

In one embodiment, a weight can be assigned B206 to the view based on the importance of the objects and actions involved.

The history repository 218, or view, can then be configured to organize and present B208 the history views according to the assigned weight. In one embodiment, the history repository 218 can eliminate views that have a weight not meeting a pre-determined weighting criteria.

In one embodiment, a threshold weight value can be established separately for each action and object. The history view can then be prioritized based on relevant objects, actions or both, that meet or exceed the established threshold values. In this fashion, the length of the history view can be controlled. For example, where a rigid set of criteria is applied, such as both action and object threshold, the history view can be much shorter than when less strict criterion is applied, such as only one of the action or object thresholds.

The action type for a view can be deduced or determined when there is interaction with the view through an operation. For example, a button can be pressed to place a call or a menu item selected to edit a contact, in respective views that correspond to such actions or operations. When such an action, or execution of an action, is detected, an action item or category can be assigned to the view, also referred to herein as an action tag. Generally, the input actions performed by the user on a given view on a particular object are identified. In one embodiment, the aspects of the disclosed embodiments can also look at the actions that are available to the user with respect to a particular view. For example, an SMS Editor view can include actions such as editing a message, sending the message, or deleting the message. In one embodiment, the action tags can include, for example send, create, change, receive, query, and read. In alternate embodiments, any suitable action tags can be used. In this example, this list of action tags is ranked or prioritized in order of importance from high to low, “send” being the highest and “read” being the lowest. The initial action tag assigned to a view is “read”. When an operation is detected, such as a press of a button(s), an edit, send, or save, or the entering of text, the initial action tag assignment is overridden and an action tag corresponding to the new action is assigned. Other actions can include a user leaving a view without performing an operation such as, for example, entering a view and then activating the back function.

In one embodiment, a special action tag can be created for views that are started, but not completed. For example, in a messaging view, the message is composed but not sent. In a telephone view, a call is attempted but the connection is not made. In both of these views, the desired operation is not completed. The special tags can be used to highlight these views since it is likely one may wish to revisit the view at some point in the future to attempt to complete the operation, such as sending the message or making the call, without the need to re-start the entire process associated therewith.

For views that have a special tag, the history view selection will bring the user to the exact view they left. In one embodiment, an instruction can be provided on how to continue or proceed in this view. Referring to the examples above, in returning to a composed message view, the instruction “edit message” can be provided. In returning to the telephone application where the call task was not completed, the instruction “call him again” can be provided. The instruction can be provided in any suitable manner, such as for example, text on the screen or view, a pop-up window, or a voice command.

For views that are not assigned a special tag, the view that will be returned to is the view corresponding to the relevant action. For example, for a view that is assigned a “read” action, the view will return or go to the latest version of the relevant view. In one embodiment, it can be possible to return to the exact view that was visited earlier. For views that are assigned action tags such as send, create, or change, the view can return to the view that contains the results after that particular action. For example, for a view with an action tag “send” the view shown can be the view showing the sent message or posted comment. For a view with “query” action, the view can return to the view prior to activating the search button.

In one embodiment, separate threshold values are set for each action and object. The history view can highlight the prioritized views in terms of the relevant object, the relevant action or both object and action. In one embodiment, all views that include special tags can be assigned high values, as these are views that are more likely to be revisited. The criteria for prioritizing views can be pre-set or configured by the user. This allows the user to control the length of the history view. The application of a rigid criteria can be used to limit the number of views in a history list.

In one embodiment, the action/object analysis can include other “invisible” objects. For example, each view will generally be associated with metadata such as location, time, temperature, battery level and signal strength, for example. In alternate embodiments, a view can be associated with any suitable metadata. The action/object view analysis can also consider such information, together with the visible object. The metadata can be used to weight each view and generate history views. The metadata can be used as criteria for the selection of a view.

FIG. 2C illustrates one embodiment of object and action based weighting in a sequence of views C200 when a user handles messages and photos. For a given view C200, the objects and actions are processed and a corresponding weight is assigned to the respective view.

With reference to FIG. 2C, the objects and actions for each view C200 are processed and analyzed. Based on the result of the analysis, a pre-defined weight can be assigned to each type of object and action. In this example, a contact object has a higher weight that a setting object. In alternate embodiments, any suitable object weighting assignment structure can be used. For actions in this example, the priority order used is Send, Create, Change, Receive, Query and Read. In alternate embodiments, any suitable priority order for actions can be established and used, and a corresponding weight assigned to the view. The aspects of the disclosed embodiments can provide a history view, such as that shown in FIG. 2C, that focuses on views with significant objects, actions or both. Individual objects or actions can be prioritized and an object can become more important when it is associated with heavy actions. For example, in FIG. 2C, in the view C214, the object Tom C216 has a heavier weighting when it is associated with the action Send C218, than when the object Tom C220 is associated with the action Read C222, in view C224.

For example, in the view “Contact List” C202, the object is the list-Contacts C204. This view C202 has an assigned action tag of “Read” C206. This can mean that the contact list was opened and viewed with no other action taken.

As another example, for the view “Lisa's photo 2” C208, the objects C210 include “contact-Lisa, photo-2, comment”, with an action tag “create” C212. This means that while in the contact view, the contact “Lisa” was viewed together with a corresponding photo, and a comment created.

In a web browser, activation of the history function usually leads to the view with exactly the same URL. Thus, a return to a messaging application view will generally return to an initial state of a view, and not necessarily the exact view the user was in previously. The aspects of the disclosed embodiments provide for the ability to return to the exact view by examining the relevant action and object. Thus, when in a messaging application view where the message is composed, but the view is exited prior to sending the message, traditional history functionality will return to the initial messaging application view. The aspects of the disclosed embodiments can return to the view where the message is composed, but not sent.

In one embodiment, the history view sequence does not have to be the same sequence or order in which a user experienced each view. Rather, certain internal views can be created or filtered out to create a custom history experience. For example, when listening to music as background, the user may not encounter a dedicated view when a song changes. However, the aspects of the disclosed embodiments can consider such changes as distinct views and record such an event as an “internal” view in creating a history item. The aspects of the disclosed embodiments can also filter some views out. The views to be filtered out can be pre-configured. In one embodiment, the filtering criteria can be the assigned action tag. In alternate embodiments, any suitable criteria can be used for the filtering criteria.

In one embodiment, relationships between neighboring views can be quantified and views can be grouped based on common objects and actions. This can be advantageous to identify different tasks from each other and provide a logical grouping for different views. For example, neighboring views can be grouped together when the views involve a common object. For example, referring to FIG. 2C, the objects Tom and Lisa are the key objects for task grouping C230. In alternate embodiments, the views can be grouped into any suitable grouping arrangements.

When a group is based on object similarity, the view with a more heavily weighted action can override the view with the weaker action. For example, when the common object between neighboring views is a photo, the action “publishing” can be assigned a greater weight that the action “view.” Thus, the view for “viewing a photo” will be overridden by the view for “publishing photo”, and the view can be combined into the single view “publishing a photo.”

When views involve a common action, the views can be grouped together. For example, the views “viewing photo A” and “viewing photo B” can be combined into a single action view “viewing photos.”

In one embodiment, a view can be assigned as a separator between different views. For example a sequence of views is broken into groups, when the home view appears in the middle of the view sequence.

FIG. 2D illustrates one example of a history view incorporating aspects of the disclosed embodiments. The history list D202 lists all previously visited views prioritized by latest D204 to earliest D206. Selection arrows D208 and D210 can be used to scroll the list to review later or earlier views, respectively. A view generally comprises the display of the view on a screen of the device, together with relevant state information D212. A state can be considered relevant if it is worthwhile to go back to the state. Relevancy is an application dependent determination. For example, a play list screen is being displayed for a music player application. The user selecting a song to play is relevant state information. A view of the user selecting a song to play from the play list screen should be recorded as a view. The view is described by the playlist screen and the selected song.

The state of a screen can change due to user interaction with the device. If the new state is relevant, the new state can generate a separate item in the history view list D202. A user navigating away from a screen will generate an item in the history view list D202. The state of a screen can also change due to the system. In one embodiment, a change in the state of a screen due to the system will not generate additional items for the history view list D202.

In one embodiment, non-important views or expired views can be filtered from the history view list D202. For example, it may not be desirable to include non-important views and expired views in the history view list D202. Non-important views can be those views that are “near”, in the navigational sense, to the home screen. An expired view can be one that is no longer active or available. Some non-important views can include, for example, History, Inbox, My Media, Contacts, Places and Home. In alternate embodiments, any suitable criteria can be used to classify non-important views. In the history view list D202, a view is shown only once, ordered by its most recent use or occurrence.

In one embodiment, background activities such as, for example, a music player playing songs in the background, will not generate items for the history view list D202. In one embodiment, if the background activity generates history items, activation of the Back function will ignore the background activity history items, similar to expired items. User interaction can trigger state changes within a screen of a user interface, as can an active application, such as for example, the music player application referenced above. If the state changes are relevant enough, they can be included in the history view list D202.

FIG. 2E illustrates and example of a history view list E202 being re-arranged as a two-level list, and grouping views into tasks. Selecting the plus (“+”) icon E204 will open a chronologically ordered list of views that the user has visited to perform a task. A given view can be listed more than once in the entire history view list. However, a given view will only be listed once for a single task, ordered by its most recent use. Selecting the task icon E206 itself will re-open the most recent view E208 of the task.

A task can be named by a combination of a strong object, person, place and/or time of the most recent user action.

The selection by the user of the Home or History functions can generate a new item in the history view list E202. A new history item gets appended to the same Task as the previous view. The creation of a new Task can also be triggered due to application specific reasons.

In one embodiment, the effect of the user selecting a view from the history view list (task switching) on the Task History is that the selected view is restored, and any interaction by the user creates a new view that is stored. For example, the user selects a view E206 from the history task list E202 of FIG. 2E. The view is restored. If the user interacts with the system, a new view corresponding to the action should be added to the history task list.

In this embodiment, the state of a screen can also change due to the system. State changes due to the system can generate additional items to the history view list.

FIG. 2F illustrates an example of use of the “Back” function in a user interface incorporating aspects of the disclosed embodiments. Generally, there are two options for a unified Back function. In one embodiment, a back function can be provided with each view, with links to the previous, non-expired view. The ordering of views can generally be from the oldest view to the earliest view. In another embodiment, there can be separate Back functions for each view. The Back function provided with each view will link to the previous, non-expired view within the same task. As shown in FIG. 2F, selection of view F204, will provide links F206, F208 and F210 to previous links within the task, identified as F204.

FIG. 2G illustrates an example of a history view list G202 where the Task History is re-arranged as a two-level list. In this example, the selection of a link, such as by tapping the plus sign E204 in FIG. 2E as described previously, can expand a view of the associated link E204. The views for the link E204 are grouped into user tasks G208 and G2102 The second level list items G208 include visited views related to the task, and additionally also links to identified Strong Object, Persons, and/or Places related to this task. These can be identified by applying the object and action analysis to the view as described herein.

In one embodiment, one or more links, such as link G214 can be added to a the history view list G202 that provides a link to strong objects. An object is generally identified as the focal point of user interaction across multiple views. For example, “Call Joe”, “SMS Joe”, “Search for Joe on Web” are actions associated with the object “Joe”. The aspects of the disclosed embodiments can provide a link G214 to a main view G212 for the object, such as “Joe's homepage”. The link G212 can be included in the history visualization, e.g. the history view list G202, even if the view related to link G212 has not been visited before. Selection of the link G21 of Object, Persons, and/or Places will open the corresponding Main View G212. As other examples, the main view for a person can be their Contact Card. A main view for an object can focus on a visual or audible representation of this object. The main view of a place can be a view to a map that includes this place.

FIG. 2H illustrates an example of a history view list. V11, V12, V13, V21, and V22 are Views. History means History view, and Home means Home view. The left column H202 lists visited views, with the most recent view at the bottom. The right column H204 shows the complete History view after step 8. View V13 is grouped to Tasks 1 and V11 and V12.

FIG. 2I illustrates another example of organizing the history view list. The history view of FIG. 2I initially offers the user a collection of strong objects, persons, or places related to more recent user action. These history items I204 can be sorted by time or most recently used. Selecting one such item I206 utilizes the strong object, person, or place as a filter on task history items. FIG. 3 illustrates one example of a user interface 300 incorporating features of the disclosed embodiments. As shown in FIG. 3 the user interface 300 includes function icons 302, 304, 306 and 308. A number of application icons can also be included such as, for example, contacts 310, inbox 312, my media 314, and Web 316. The application icons can include icons for webpages and local applications. Thus, for example, contacts 310 can take the user to a contact application stored or accessed locally by the device. The Web icon 316 can take the user to a webpage or Web application.

The frequent area 318 can provide the user with the ability to open or launch applications that are frequently used. The favorites area 320 will allow the user to store links to webpages or applications. Activating any one of the links within the frequent area 318 or favorite area 320 will launch the corresponding webpage or application. The library 140 of FIG. 1 will record and track each state. In one embodiment, this can allow the user to return to a certain state.

In one embodiment, the system 100 comprises a mobile communication device. The mobile communication device can be Internet enabled. Some of the applications of the device may include, but are not limited to, in addition to those described above, data acquisition (e.g. image, video and sound) and multimedia players (e.g. video and music players). In alternate embodiments, the system 100 can include other suitable devices and applications. The aspects of the disclosed embodiments are well suited for desktop but also non-desktop types of devices, such as for example mobile communication devices. Mobile communication devices typically have less screen space and different input methods than conventional desktop devices. Due to the limited screen space in mobile communication devices it is not always possible to represent more than one window simultaneously. Switching between windows can be difficult as well. The aspects of the disclosed embodiments provide a windowless navigation model where each view is provided in the same window and switching between windows to go from one application to another is not required.

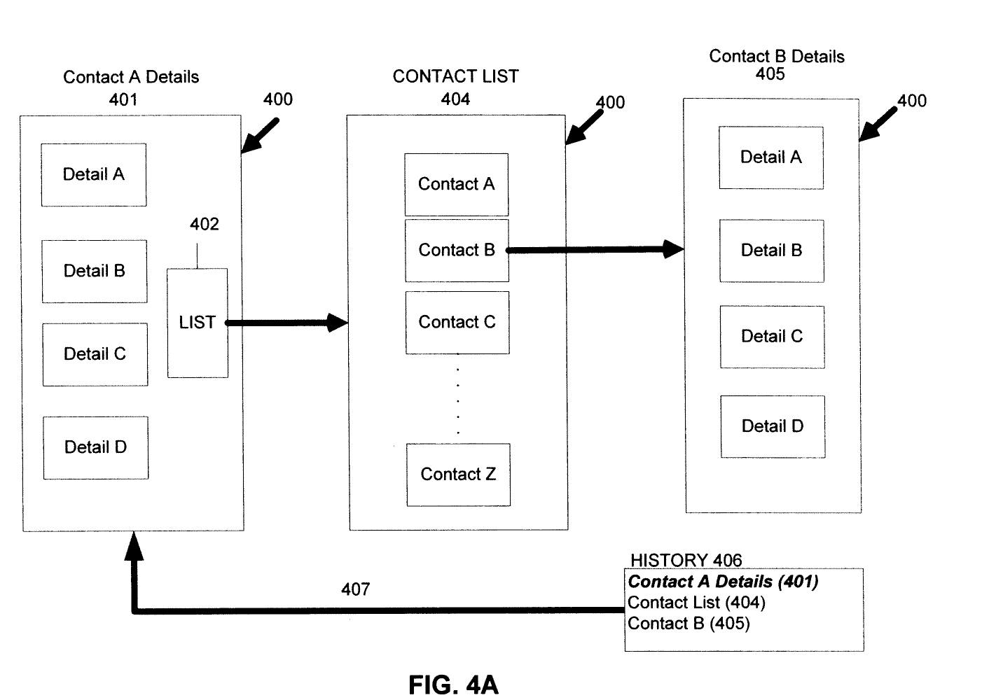

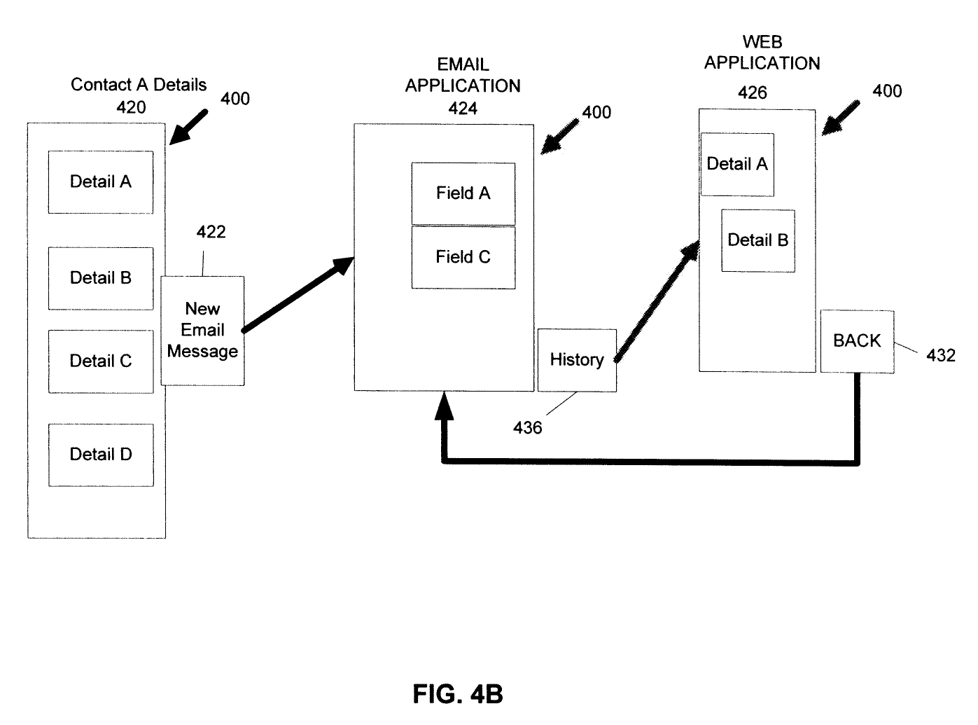

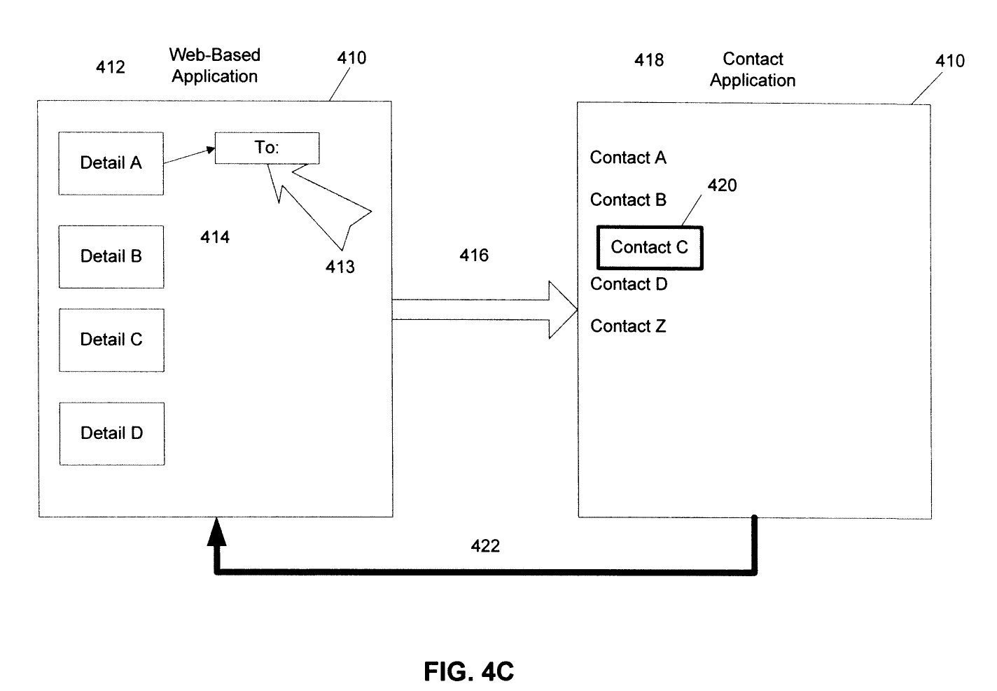

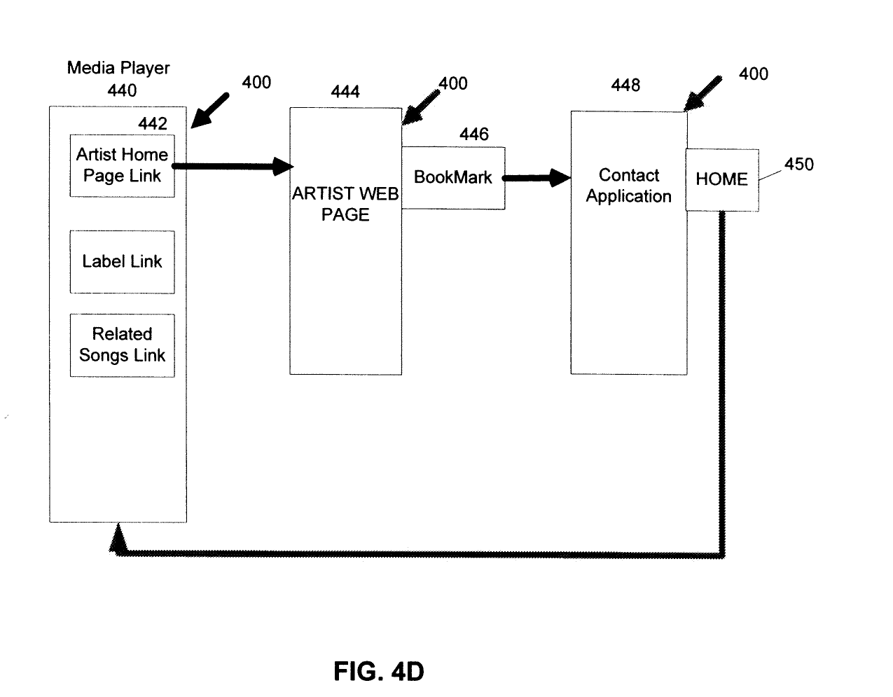

Referring to FIGS. 3 and 4A, one example of navigation between the views of a local application is illustrated. In this example, the user has accessed contacts application 310. Contacts application 310 allows the user to view details of a contact, such as contact A, that are stored in the contact application 310. The details related to contact A are presented in the main view 400 of the user interface 300. As shown in FIG. 3, in one embodiment, the user interface 300 includes a main viewing area 301a, where application related information is presented. A menu bar 301b is shown on the side of the viewing area 301a, where the back, home, history and find function icons are shown. Another row of controls is shown along a top portion of the viewing area 301a.

After viewing the details related to Contact A in state 401, the user selects to view the Contact list 402, which is presented in view 400 shown in State 404. From within State 404, the user selects to view the details related to Contact B, which are then presented in view 400 in State 405. If the user then selects, from a recent history view list 406, “Contact A Details”, the user is returned 407 to the state and view represented in State 401.

In FIG. 4B, an example of navigating across application boundaries while navigating local application views is illustrated. Here, the user is in a contact application and is viewing details pertaining to Contact A, as shown in State 420. While viewing the contact details in State 420, the user selects or activates a function 422 to create an email message. This navigates the user interface to State 424 where the email messaging application view is displayed. While in the email message application, the user activates the history function 436 of the device, such as by selecting history 306 in FIG. 3. From the history function 436 the user selects a link to a web page or web application. The web application is launched and the user interface 400 presents the results of navigating to the state 426. The user then, while in the web application state 426, activates the Back function 432, such as by selecting 302 in FIG. 3, and the user interface 400 presents the result of navigating back to the prior state 424, the email application.

Referring to FIG. 4C, an example of navigating between application and web page views in accordance with the aspects of the disclosed embodiments is illustrated. In this example the user has selected or opened a web-based application 412, which corresponds to a Christmas card sending Web application. The page corresponding to the web-based application 412 is shown in the window 410 on a display of user interface, such as user interface 300 of FIG. 3. In this example the user needs to fill in a number of form fields of the application 412, which are indicated as Detail A, B, C and D. Each detail can call for an input of certain information. In this example the Detail A calls for the input of a recipient address 413, such as, for example, an e-mail address. Selection of the field 413 will automatically navigate to a local contacts application from which appropriate contact details can be selected. Thus, as shown in FIG. 4C, the window 410 navigates 413 from a view of the web-based application 412 to a view of the contact application 418. From within this application the user can select from any one of a number of contacts or contact information. In this example, the user selects 420 contact C. Once Contact C is selected, the view reverts back 422 to the view of the web based application 412 window. The contact data for Contact C can be automatically inserted into the required parameter field. During this process, the user is presented with a single window 410 that automatically traverses to the required application and page views.

The aspects of the disclosed embodiments provide for a step by step recording of states for both back and history navigation. All views are recorded and retrievable. As noted herein, in one embodiment, each distinct state can be recorded by the UI state recording engine 136 so that the user can navigate back to a specific state. However, depending on the number of distinct states viewed, the number of states that are recorded can become overwhelming. In one embodiment, a concise history abstraction can be created that allows for a more simplified view retrieval based on action types. For example, referring to FIG. 4C., the web-based application view 412 and contact application view 418 are related to the task of sending a message. While each view state described with respect to FIG. 4C can be recorded, the user may not have any need to return to the state of the view 412, view 418 or even the view 422 after the message is sent out. However, the user may be interested in determining if the message that is created is sent. In one embodiment, when the message is sent a new view is created that can be called, for example, “Message sent to Contact C.” When traversing the history, back or other state recording function, the user can go directly to this “message sent” view from any application view or state. This type of history abstraction applies the action of “sending something to others” and to some extent, “adding something to the device.”

Similarly, the history abstraction can be applied when browsing content. Rather than recording a distinct state for each content item viewed, content or projects can be group together by the action type. For example, when browsing a group of pictures, the selection of each picture can create a distinct view state. In one embodiment, the view state can be abstracted to “browsing pic A and others”, for example. The abstracted view state for this multiple step task is recorded for later retrieval.

In one embodiment, the abstraction can be based on object types. For example, referring to FIG. 4A, the history list 406 can be configured to only include state history related to the contact list 404, as it presents an overview of the contact list. The contacts for which the contact details are viewed, such as contact B, can be highlighted in the state of the history list 406 differently from other entries in order to signify that the details were viewed.

In one embodiment, each entry in the task history list 406 is a previously performed task. The list item can include an action (a verb) and at least one object (for example, an image or other media content, a person or place). In alternate embodiments, any suitable object can be included. The visual representation can be textual and/or iconic.

In one embodiment, the object can be or include a hyperlink. Selecting the hyperlink can cause the task history list 406 to be filtered, so that only the tasks related to this object are presented in the list. In one embodiment, the whole list entry is a hyperlink that triggers a re-opening of the respective application in the recorded state. Objects within the list can also be hyperlinks. Selecting one of those hyperlinks can have a different effect.

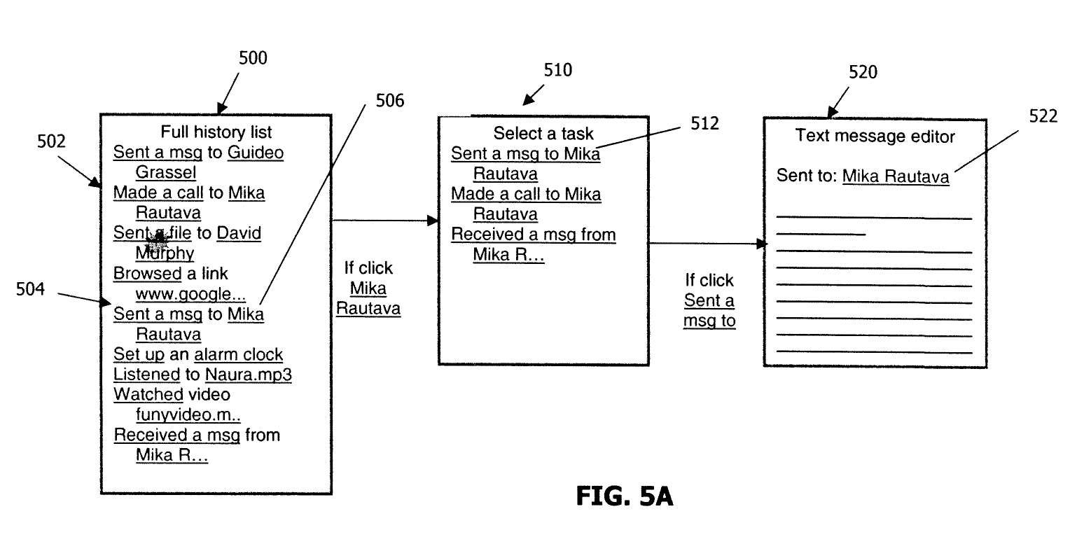

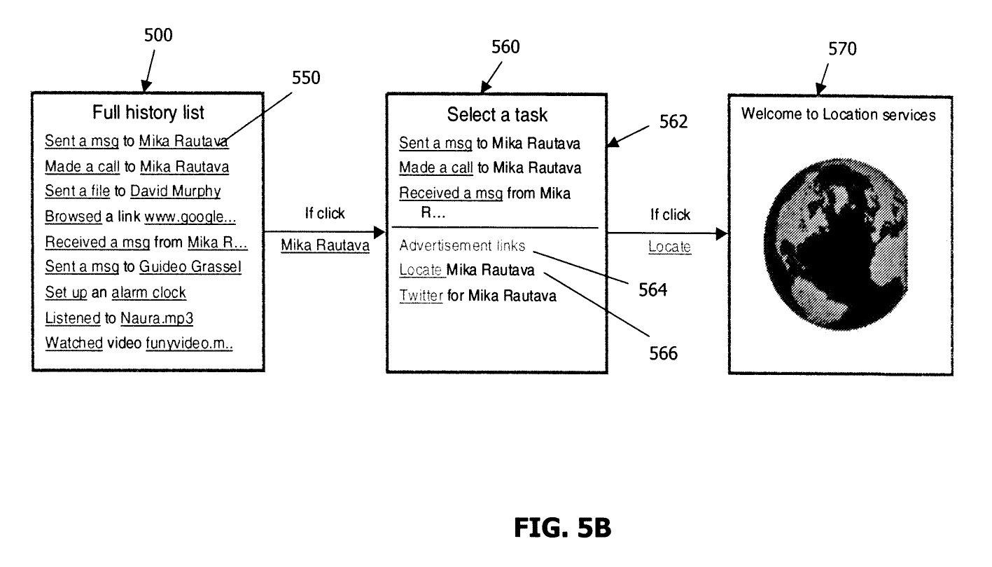

In one embodiment, the task history for such multiple step tasks are stored, for example in the state recording engine 136, and can be searched or queried using keywords. The key words can comprise the user action and object or object structure. For example, referring to FIG. 5A, a multiple step task history list 500 is shown. Each entry in the list 500, such as entry 502 includes a user action 504 and an object 506. When the abstracted view state is created, the user task history is structured so that the keywords are recorded and enabled to be searchable. In one embodiment, repeating a task, such as task 502, only requires conducting a new search using the same keywords.

By structuring the task history using keywords, each element or keyword can be used as a filter to narrow down the task candidates and lead to a specific task item and state view. For example, in the history list 500, the keywords “Sent a message” 504 and “Mika Rautava” 506 in the state entry 502 are enabled as hyperlink anchors. In one embodiment, the hyperlink anchors can be distinguished from other hyperlinks using any suitable highlighting mechanism such as, for example, color, font, icon or size. If the user desires to see or search what actions or tasks stored in the history list relate to “Mika Rautava”, the user can “click” or otherwise activate the hyperlink anchor 506. The corresponding search will generate a listing of tasks stored in the full history list 500 as shown in screen 510. The list of tasks shown are all tasks stored in the history list where the object is “Mika Rautava”, such as “Sent a msg to Mika Rautava” 512. By activating the hyperlink anchor associated with the entry 512, the user can navigate to the text message editor view 520 in which the message 522 that was sent to Mika Rautava can be viewed. This aspect of the disclosed embodiments provides a filtering mechanism that allows the task or view state history to be searched.

Referring to FIG. 5B, in one embodiment, the history function can be used as a mechanism for advertisement related to history searching. For example, the user has accessed the history list 500 and desires to search tasks related to the object “Mika Rautava.” By activating the hyperlink 550, the full history list 500 is searched for task entries related to the search criteria “Mika Rautava.” In screen 560, the task views that are recorded related to “Mika Rautava” are shown in the list 562. Advertisement links 564 are shown in a different part of the display 560. Selecting the “Locate” advertisement link 566 can take the user to a Location Services 570 application. In the embodiment shown in FIG. 5B, the advertisements are only shown when the user starts to narrow down the history events or views. In alternate embodiments, the advertisements, which are not limited by the examples shown with respect to FIGS. 5A and 5B, can be presented to the user at any suitable time and in any suitable fashion.

Another example of navigating between applications and web pages is shown in FIG. 4D. Here, the user has selected the “my media” function or link 314 of FIG. 3 which takes the user to a media player application, represented by state 440. While in the media player application, the user selects a link 442 from within the application that takes the user to the music artist's home page, represented by state 444. The home page is rendered to the device using a web browser application. While in the state 444, the user, using bookmark function 446 of the device, activates a link to open a contact application, which renders the device to state 448, where the user could create a contact for the artist or take other action. From state 448, the user can activate the home function 450 of the device, which reverts the user interface back to the media player application of state 440, which was the initial state of the sequence.

During web browsing, individual views are treated and units of analysis. A history function collects information related to a user's recent activity and a list of views visited can be created and stored. The aspects of the disclosed embodiments provide for analyzing and identifying the most important views to provide a manageable and concise history list.

Referring to FIG. 1, in one embodiment, the user interface of the disclosed embodiments can be implemented on or in a device that includes a touch screen display, proximity screen device or other graphical user interface. This can allow the user to interact easily with the user interface for navigating in and among applications as described herein. In alternate embodiments, the aspects of the user interface disclosed herein could be embodied on any suitable device that will display information and allow the selection and activation of applications or system content. In one embodiment, the display 114 can be integral to the system 100. In alternate embodiments the display may be a peripheral display connected or coupled to the system 100. A pointing device, such as for example, a stylus, pen or simply the user's finger may be used with the display 114. In alternate embodiments, any suitable pointing device may be used. In other alternate embodiments, the display may be any suitable display, such as for example a flat display 114 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

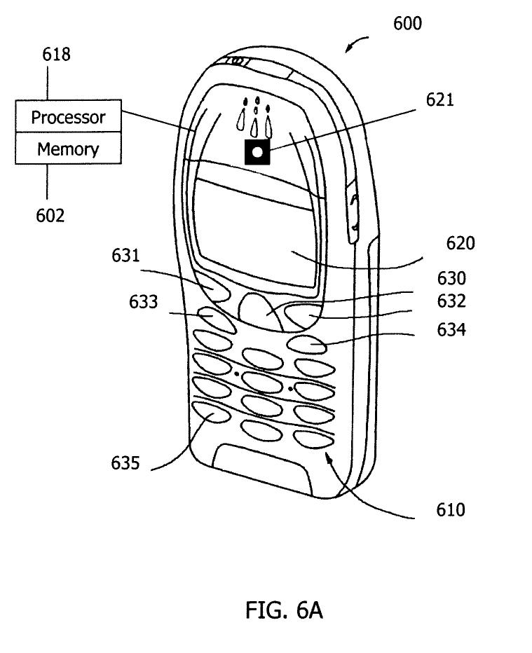

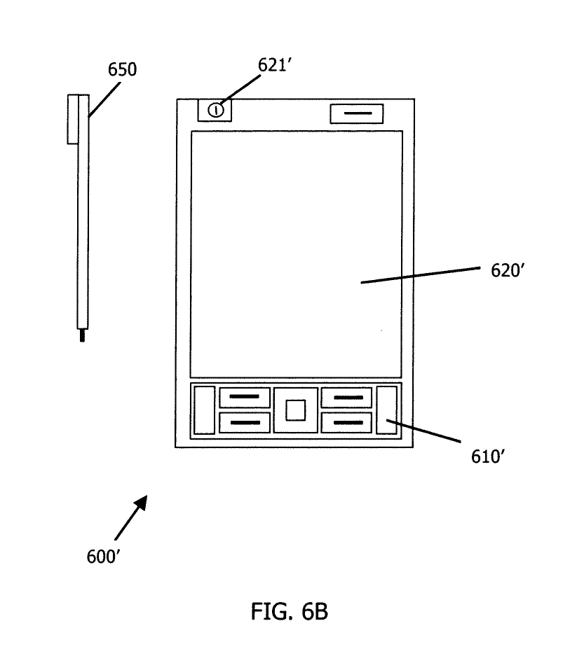

Some examples of devices on which aspects of the disclosed embodiments can be practiced are illustrated with respect to FIGS. 6A and 6B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s), such as the functions 302-316 described with reference to FIG. 3.

As shown in FIG. 6A, in one embodiment, the terminal or mobile communications device 600 may have a keypad 610 as an input device and a display 620 for an output device. The keypad 610 may include any suitable user input device such as, for example, a multi-function/scroll key 630, soft keys 631, 632, a call key 633, an end call key 634 and alphanumeric keys 635. In one embodiment, the device 600 includes an image capture device such as a camera 621, as a further input device. The display 620 may be any suitable display, such as for example, a touch screen display or graphical user interface. The display may be integral to the device 600 or the display may be a peripheral display connected or coupled to the device 600. A pointing device, such as for example, a stylus, pen or simply the user's finger may be used in conjunction with the display 620 for cursor movement, menu selection and other input and commands. In alternate embodiments, any suitable pointing or touch device may be used. In other alternate embodiments, the display may be a conventional display. The device 600 may also include other suitable features such as, for example a loud speaker, tactile feedback devices or connectivity port. The mobile communications device may have a processor 618 connected to the display for processing user inputs and displaying information and links on the display 620, as well as carrying out the method steps described herein. A memory 602 may be connected to the processor 618 for storing any suitable information, data, settings and/or applications associated with the mobile communications device 600.

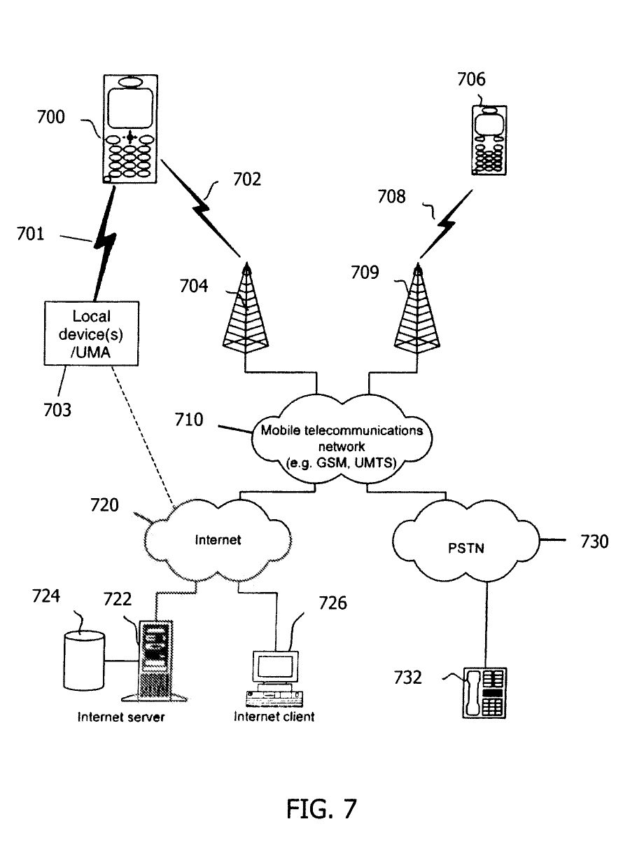

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 700 and other devices, such as another mobile terminal 706, a line telephone 732, a personal computer 751 and/or an internet server 722.

In one embodiment the system is configured to enable any one or combination of chat messaging, instant messaging, text messaging and/or electronic mail. It is to be noted that for different embodiments of the mobile terminal 700 and in different situations, some of the telecommunications services indicated above may or may not be available. The aspects of the disclosed embodiments are not limited to any particular set of services or communication system or protocol in this respect.

The mobile terminals 700, 706 may be connected to a mobile telecommunications network 710 through radio frequency (RF) links 702, 708 via base stations 704, 709. The mobile telecommunications network 710 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide area network 720, which may be the Internet or a part thereof. An Internet server 722 has data storage 724 and is connected to the wide area network 720, as is an Internet client 726. The server 722 may host a worldwide web/wireless application protocol server capable of serving worldwide web/wireless application protocol content to the mobile terminal 700.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 to one or more local devices 703. The local links 701 may be any suitable type of link or piconet with a limited range, such as for example Bluetooth™, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values or other signals to the mobile terminal 700 over the local link 701. The above examples are not intended to be limiting, and any suitable type of link or short range communication protocol may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 includes communications module 134 that is configured to interact with, and communicate to/from, the system described with respect to FIG. 7.

Although the above embodiments are described as being implemented on and with a mobile communication device, it will be understood that the disclosed embodiments can be practiced on any suitable device incorporating a display, processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 600′ illustrated in FIG. 6B. The personal digital assistant 600′ may have a keypad 610′, a touch screen display 620′, camera 621′ and a pointing device 650 for use on the touch screen display 620′. In still other alternate embodiments, the device may be a personal computer, a tablet computer, touch pad device, Internet tablet, a laptop or desktop computer, a mobile terminal, a cellular/mobile phone, a multimedia device, a personal communicator, a television or television set top box, a digital video/versatile disk (DVD) or High Definition player or any other suitable device capable of containing for example a display 114 shown in FIG. 1, and supported electronics such as the processor 618 and memory 602 of FIG. 6A. In one embodiment, these devices will be Internet enabled and can include map and GPS capability.

The user interface 102 of FIG. 1 can also include menu systems 124 coupled to the processing module 122 for allowing user input and commands. The processing module 122 provides for the control of certain processes of the system 100 including, but not limited to the controls for selecting files and objects, establishing and selecting search and relationship criteria and navigating among the search results. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages, notifications and state change requests. Depending on the inputs, the process module 122 interprets the commands and directs the process control 132 to execute the commands accordingly in conjunction with the other modules, such as UI state recording module 136, activation module 137, state manager 138 and state listener module 140.

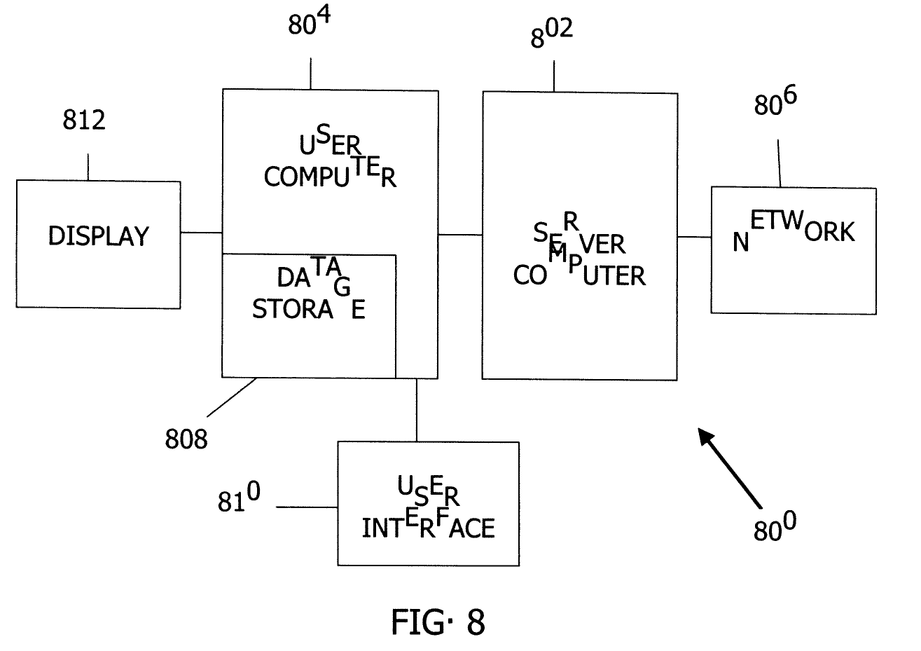

The disclosed embodiments may also include software and computer programs incorporating the process steps and instructions described above. In one embodiment, the programs incorporating the process steps described herein can be executed in one or more computers. FIG. 8 is a block diagram of one embodiment of a typical apparatus 800 incorporating features that may be used to practice aspects of the invention. The apparatus 800 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 800. The memory can be direct coupled or wireless coupled to the apparatus 800. As shown, a computer system 802 may be linked to another computer system 804, such that the computers 802 and 804 are capable of sending information to each other and receiving information from each other. In one embodiment, computer system 802 could include a server computer adapted to communicate with a network 806. Alternatively, where only one computer system is used, such as computer 804, computer 804 will be configured to communicate with and interact with the network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or other suitable connection, line, communication channel or link. In one embodiment, the communication channel comprises a suitable broad-band communication channel. Computers 802 and 804 are generally adapted to utilize program storage devices embodying machine-readable program source code, which is adapted to cause the computers 802 and 804 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the disclosed embodiments may be stored in one or more computers 802 and 804 on an otherwise conventional program storage device. In one embodiment, computers 802 and 804 may include a user interface 810, and/or a display interface 812 from which aspects of the invention can be accessed. The user interface 810 and the display interface 812, which in one embodiment can comprise a single interface, can be adapted to allow the input of queries and commands to the system, as well as present the results of the commands and queries, as described with reference to FIG. 1, for example.

The aspects of the disclosed embodiments apply Web style navigation methods across applications and webpages, whether local or web-based. Hypertext navigation methods used in the web are extended to local applications. Local and web applications are mixed seamlessly so that the user does not perceive any difference between navigation within either one of, or between, those types of applications. The navigation model of the disclosed embodiments is windowless, meaning that a user does not have to open, close or switch between windows in order to move between different types of applications and different views. Rather, the user navigates between different UI states, in and out of different types of applications. Navigation from view to view is accomplished using hyperlinks, one view at a time. All views and states of views are recorded and the user can switch to a previous view, in the state in which it was viewed, using a back, history or other suitable state recording and retrieval function. The aspects of the disclosed embodiments allow a user to navigate in and about both local and web-based applications, or a combination of both, in a seamless and simplified manner. Selecting different windows to view different applications or access different view states is not needed as each view, whether for a local application or web application, is provided in a seamless fashion in the user interface of the device.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
opening a first application view in a window of a user interface;
detecting an activation a link to a second application view while a state of the user interface is in the first application view;
opening the second application view in the window of the user interface; and
detecting a selection of a function in a state of the user interface in the second application view as a command to automatically return to the state of the user interface in the first application view in the window of the user interface; and
returning the state of the user interface to the first application view.

2. The method of claim 1 wherein the function is a back function of the user interface and wherein detecting an activation of the back function returns the user interface to an exact state of a previous view prior to detecting an activation of a link to a next view.

3. The method of claim 1 wherein the link to the second application view is selected from a bookmarks application of the user interface.

4. The method of claim 1 further comprising:
identifying each object and each action executed with respect to each view that is opened;
assigning a weight to the each view based on the identified objects and the executed action; and
generating a history view that includes only those views that satisfy a pre-determined weighting criteria.

5. The method of claim 4 further comprising, if a view does not have an object, assigning a corresponding object to the view.

6. The method of claim 4 further comprising, after identifying each object, identifying a level associated with each object, the level corresponding to an importance of the object to the view, and determining the main object based on the identified levels.

7. The method of claim 6 further comprising, providing, in a view in the history list, a link to a main view for the determined main object when the level corresponding to an importance of the object to the view is a strong object level.

8. The method of claim 4 wherein the history view prioritizes views based on an object weighting, an action weighting or a combination of object weighting and action weighting.

9. The method of claim 1 further comprising, in response to an opening of a view:
assigning a default action tag to the view, an action tag corresponding to an operation available to be executed with respect to the view;
detecting execution of an operation corresponding to the view and determining a corresponding action tag category; and
assigning a new action tag to the view corresponding to the determined action category.

10. The method of claim 9 further comprising, after assigning the default action tag:
determining that execution of an operation corresponding to the view is not complete; and
assigning a special action tag to the view that identifies the view as not complete, the special action tag being configured to return the view to the incomplete state of the view when the view with the special action tag is selected from the history view.

11. The method of claim 9, further comprising, when a view is selected from the history view, identifying an action tag associated with the selected view, and opening a latest version of the view corresponding to the action tag.

12. A method comprising:
detecting an activation of a link to a first application to open a view to the application in a window of a user interface;
detecting an activation of a link to a second application from within a state of the first application view to open a view to the second application;
detecting a selection a data item from the view to the second application; and
automatically switching back to the first application view in the window after detecting the selection of the data item.

13. The method of claim 12 further comprising:
recording each state of the user interface in a state recording function of the user interface;
allowing a selection of each stored state in order to return to the recorded state.

14. The method of claim 12 further comprising detecting a selection of a recorded state to return to an exact view of the recorded state as it existed before activation of a next state.

15. The method of claim 12 further comprising, prior to recording the state:
identifying an action type of the state;
identifying an object of the action type;
abstracting the action type and object type to create an abstracted state to be recorded; and
recording only the abstracted state.

16. The method of claim 15 further comprising storing the action type and object type in the abstracted state as hyperlink anchors in a descriptor for the abstracted state.

17. The method of claim 16 further comprising detecting a selection of a hyperlink anchor in the descriptor for a stored abstracted state to search for all recorded instances of states corresponding to the hyperlink anchor, and presenting a list of search results, where each recording instance in the list of search results corresponds to a state of a view.

18. The method of claim 13 further comprising highlighting, in the view corresponding to the abstracted state, each object for which a recorded state exists.

19. The method of claim 13 further comprising creating a hypertext link for each state of any local and web-based view, storing the hypertext link, and accessing the hypertext link to relaunch a view of the local application when a request for the state of the view is detected.

20. The method of claim 13 wherein the user interface comprises a single window in which each application view is displayed.

21. An apparatus comprising:
a user interface configured to display a state of at least one application view in a window;
a state recording engine configured to identify and record each state of the at least one application view on the user interface of a device;
a state manager configured to receive a request for a state change and forward the request to the state recording engine for recording;
an activation module configured receive the state change request from the state manager and open a view corresponding to the state change request in the window of the user interface.

22. The apparatus of claim 21 further comprising that one application view is for a local application and another application view is for a web-based application, wherein both application views are displayed separately in the window.

23. The apparatus of claim 21 further comprising at least one state change listener for each application of the device, the at least one state change listener configured to notify the state recording engine of a state change of a corresponding application.

24. The apparatus of claim 21 wherein the state manager is further configured to create a hypertext link for the state of the displayed application view and store the hypertext link in the state recording engine.

25. The apparatus of claim 21 wherein the activation module is further configured to automatically close one application view prior to launching a view to another application.

26. The apparatus of claim 21 further comprising a system user interface module configured to determine if a state change request pertains to a current application or a new application, force the current application to change state if the request pertains to the current application or start the new application of the request pertains to the new application.

27. The apparatus of claim 21 wherein the apparatus comprises a mobile communication device.

28. A computer program product stored in a memory comprising computer readable program code means for executing the method according to claim 1.

29. A computer program product stored in a memory comprising computer readable program code means for executing the method according to claim 12.
